(19) United States
(12) Patent Application Publication
(10) Pub. No.: US 2006/0263570 A1
(43) Pub. Date: Nov. 23, 2006

(54) Thermal lamination module

(76) Inventor: Michael H. Bunyan, Chelmsford, MA (US)

Correspondence Address: GOSZ AND PARTNERS, LLP, 450 BEDFORD STREET, LEXINGTON, MA, 02420, US

(21) Appl. No.: 11/436,329

(22) Filed: May 18, 2006

Related U.S. Application Data
(60) Provisional application No. 60/682,500, filed on May 19, 2005.

(51) Int. Cl. B32B 3/02

(52) U.S. Cl. 428/68; 428/76

(57) ABSTRACT

The present invention discloses a thermal laminate for the dissipation of heat generated in the vicinity of an installed PCMCIA card. The thermal laminate includes a top film layer, a middle gap filler layer and a bottom layer. The top film layer provides a protective, non-resistive, low friction surface with a soft conformal interface for enhancing the workability of the thermal laminate. The middle gap filler layer is disposed underneath the top film layer and provides a conformal thermal pathway for the heat radiation emitted from the installed PCMCIA card. The bottom layer is disposed underneath the middle gap filler layer and provides a grip to the middle gap filler layer and the top film layer. The bottom layer is made from either a thermal adhesive layer or a copper foil layer. The thermal laminate utilizes sliding contacts for proper housing between a PCMCIA card surface and a heat sink surface to provide better thermal management within an assembly.

### CROSS-REFERENCE TO RELATED APPLICATIONS

This application claims the benefit of priority from U.S. Provisional Application No. 60/682,500, filed on May 19, 2005, which is incorporated herein by reference in its entirety.

### BACKGROUND OF THE INVENTION

The present invention relates to thermal management devices for electronic circuit boards, and more specifically; to a thermal laminate providing dissipation of heat generated on and around a PCMCIA card installed in an electronic device, such as a laptop, a notebook, a sub-notebook, cellular phone, etc.

In recent years electronic devices have become smaller and more densely packed. Designers and manufacturers are now facing the challenge of dissipating the heat which is ohmic in nature or otherwise generated in built in electronic components. Thermal management refers to the ability to keep temperature-sensitive elements in an electronic device within a prescribed operating temperature. Thermal management has evolved to address the increased temperatures created within such electronic devices as a result of the increased processing speed and power of these electronic devices. The new generation of electronic components squeeze more power into a smaller space; and hence the relative importance of thermal management within the overall product design continues to increase. For example, in the last several years processing speeds of electronic systems have climbed from 25 MHZ to over 1000 MHZ. Each of these increases in processing speed and power generally carry with it a “cost” of increased heat dissipation.

The electronic devices in current use include various electronic components, such as transistors, microprocessors, and memory cards or other expansion cards. The electronic components are more prone to failures or malfunctioning at higher temperatures. The electronic components are small sized and the generation of even a moderate amount of heat can create excessive operating temperatures in such components, which can be very detrimental.

The computer expansions card are produced under the auspices of the Personal Computer Memory Cards International Association, commonly referred to as “PCMCIA” cards. PCMCIA cards can greatly enhance the performance of the electronic devices in many ways to customize the user's abilities. The PCMCIA cards are especially targeted toward small, highly portable electronic devices, such as “laptops”, “notebooks” “sub-notebooks”, cellular phones, etc., and can also provide expanded memory, fax, modem, network and various other expansion features for the associated devices.

Heat generated within an electronic component must be removed to the ambient environment to maintain the junction temperature of the component within safe operating limits. In this context, electronic components within the electronic devices have been cooled via forced or convective circulation of air within the housing of the device. In this regard, cooling fans have been provided as an integral part of the component package or as separately attached thereto for increasing the surface area of the package exposed to convectively-developed air currents. Electric fans have also been employed to increase the volume of air which is circulated within the housing of the electronic devices. However, a simple circulation of air is typically insufficient to adequately cool the high powered and densely packed electronic components, such as PCMCIA cards, or other expansion cards.

An integral part of a thermal design process is the selection of the optimal Thermal Interface Material (“TIM”) for a specific product application. Hence, new designs have been devised for thermal management to help dissipate the heat from electronic devices for further enhancing their performance. Other thermal management techniques utilize other concepts, such as a “cold plate” or other heat sinks which can be easily mounted in the vicinity of the electronic components for heat dissipation. The heat sink may be a dedicated, thermally-conductive metal plate, or simply the chassis or circuit board of the device. To improve the heat transfer efficiency through the interface, a layer of a thermally-conductive, electrically-insulating material is typically interposed between the heat sink and the electronic component to fill in any surface irregularities and eliminate air gaps.

U.S. Pat. No. 6,054,198, issued to Bunyan et al., and commonly assigned, discloses a thermally-conductive interface for cooling a heat-generating electronic component having an associated thermal dissipation member such as a heat sink. The interface is formed as a self-supporting layer of a thermally-conductive material which is form-stable at normal room temperature in a first phase, and substantially conformable in a second phase to the interface surfaces of the electronic component and thermal dissipation member. The material has a transition temperature from the first phase to the second phase which is within the operating temperature range of the electronic component.

U.S. Pat. No. 6,705,388, issued to Sorgo, discloses a thermal dissipater disposed in a heat transfer relationship with a heat-generating source, such as an electronic component, which is mounted on a substrate, such as a printed circuit board. The dissipater includes a thermal dissipation member having a top and bottom surface, and a pressure sensitive adhesive layer disposed on the thermal dissipation member to cover at least a portion of the bottom surface thereof. The thermal dissipation member is formed of a thermally-conductive, electrically-nonconductive ceramic material. The pressure sensitive adhesive layer has an inner surface adhered to the bottom surface of the thermal dissipation member, and an outer surface bondable to a heat transfer surface of the source for attaching the dissipater to the source in a heat transfer relationship therewith.

U.S. Pat. No. 6,965,071, issued to Watchko, discloses heat dissipation and electromagnetic interference (EMI) shielding for an electronic device having an enclosure. An interior surface of the enclosure is covered with a conformal metallic layer which, as disposed thermally adjacent to one or more heat-generating electronic components or other sources contained within the enclosure, may provide both thermal dissipation and EMI shielding for the device. The layer may be sprayed onto the interior surface in a molten state, and solidified to form a self-adherent coating.

U.S. Published Patent Application No. 20010008821, to Russell, discloses a thermally insulating textile adapted to provide a variable degree of thermal insulation dependent on ambient temperature, comprising a laminate of two fabric layers having interposed therebetween a bulking layer, which may comprise one or more fabric layers onto which is deposited a shape memory polymer in a repeating pattern. The bulking layer is adapted to cooperate with the fabric layers to vary the gap therebetween, and to provide a differential of the textile temperature from a predetermined temperature.

When PCMCIA cards are incorporated in larger computers, such as desktops or other related devices, the cooling is generally accomplished by forced convection which may serve to provide some cooling for the PCMCIA cards. An external cooling system in the computer can also serve to provide such cooling. In portable electronic devices, however, the cooling of a PCMCIA card is not a simple matter. A thermal convection mechanism for heat dissipation is effectively negligible in the typical PCMCIA card as the card is tightly surrounded by a card receiver, various connectors and assorted computer components, many of which are also heat-generating structures.

The prior art provides different means for heat dissipation, such as through a thermally insulating textile adapted to provide a variable degree of thermal insulation, and a conformal metallic layer to provide both thermal dissipation and EMI shielding, among many possible alternatives.

Accordingly, it is an objective of the present invention to provide a thermal laminate with a soft conformal, low friction surface for the dissipation of heat generated in the vicinity of a PCMCIA card installed on an electronic device.

It is another objective of the present invention to provide a thermal laminate with sliding contacts for close mating between interfacing surfaces to provide better thermal management within an assembly.

It is yet another objective of the present invention to provide a process for assembling a thermal laminate.

### SUMMARY OF THE INVENTION

There is a need for an improved thermal laminate for dissipating heat in the vicinity of a PCMCIA card. The thermal laminate of this invention utilizes sliding contacts for proper movement within the assembly, and a close mating between a heat sink surface and the PCMCIA card for better thermal management. Moreover, the thermal laminate provides soft conformal, low friction interfacing surfaces which are highly desirable for the thermal laminate when in use.

In carrying out principles of the present invention, in accordance with a preferred embodiment thereof, an electronic device is provided and includes a housing portion having support means therein for operatively supporting a PCMCIA card inserted into the interior of the housing portion. Additionally, the principles of the present invention can also be used to advantage with other types of electronic devices.

To address the deficiencies of the prior art, the present invention provides a thermal laminate for efficiently removing operating heat generated by the inserted PCMCIA card. In an embodiment of the present invention, a thermal laminate for dissipation of heat generated in the vicinity of a PCMCIA card is disclosed. From a broad perspective, the thermal laminate includes a top film layer, a middle gap filler layer and a bottom layer. The top film layer provides an interface with the thermal laminate by providing enveloping edges beyond the middle gap filler layer and the bottom layer. The middle gap filler layer is disposed underneath the top film layer to provide a conformal thermal pathway for heat radiations emitted from the PCMCIA card. The bottom layer is disposed underneath the middle gap filler layer and provides a grip for the middle gap filler layer and the top film layer. The bottom layer is selected from either a thermal adhesive layer or a copper foil layer.

In another embodiment of the present invention, a thermal laminate for dissipating heat is disclosed. The thermal laminate includes a top film layer and a gap filler layer. The top film layer provides a low friction sheath for the thermal laminate. The gap filler layer is positioned underneath the top film layer. The gap filler layer provides a thermal pathway for the heat radiation generated on an installed PCMCIA card. The top film layer provides enveloping edges beyond the gap filler layer to form a structure for the thermal laminate.

The thermal laminate, described in the aforementioned embodiments, provides a low friction surface with a soft conformal interface for a proper housing within the assembly. Moreover, the thermal laminate provides sliding contacts between a PCMCIA card surface and a heat sink surface for a proper housing within the assembly, which in turn provides a close mating for better thermal management.

In yet another embodiment of the present invention, a method of assembling a thermal laminate is disclosed. The method includes forming a top film layer. The top film layer provides an interface to the thermal laminate. The interface provides a low friction surface, a high tear resistive surface, and a soft conformal surface for the thermal laminate. The method further includes forming a middle gap filler layer. The middle gap filler layer provides a thermal pathway for the heat radiation emitted from the installed PCMCIA card. The method further includes forming a bottom layer to provide a grip for the middle gap filler layer and the top film layer. The method further includes sandwiching the middle gap filler layer between the top film layer and the bottom layer to assemble the thermal laminate. The bottom layer is selected from either a thermal adhesive layer or a copper foil layer. The top film layer provides enveloping edges beyond the middle gap filler layer and the bottom layer.

In yet another embodiment of the present invention, a method of assembling a thermal laminate is disclosed. The method includes forming a top film layer. The top film layer provides an interface for the thermal laminate. The interface provides a low friction surface, a high tear resistive surface, and a soft conformal surface for the thermal laminate. The method further includes forming a gap filler layer to provide a thermal pathway for the heat radiation emitted from the PCMCIA card. The gap filler layer is disposed underneath the top film layer. The gap filler layer provides a grip for the top film layer. The top film layer provides enveloping edges beyond the gap filler layer to form a structure for the thermal laminate.

In yet another embodiment of the present invention, a method of placing a thermal laminate on an assembly to provide dissipation of heat on a PCMCIA card is disclosed. The method includes positioning the thermal laminate between a PCMCIA card and a heat sink to provide heat dissipation in the vicinity of the PCMCIA card within the assembly.

### BRIEF DESCRIPTION OF THE DRAWINGS

The present invention is illustrated by way of example and not limitation in the accompanying figures, in which like references indicate similar elements, and in which:

FIG. 1 represents a perspective view of an assembly having a heat sink therein, in accordance with an exemplary embodiment of the present invention.

FIG. 2 represents a front sectional view of a thermal laminate, in accordance with an embodiment of the present invention.

FIG. 3 represents a perspective view of the thermal laminate described in FIG. 2.

FIG. 4 represents an assembly with a thermal laminate disposed between a heat sink and a PCMCIA card, in accordance with an exemplary embodiment of the present invention.

FIG. 5 represents a front sectional view of a thermal laminate, in accordance with a second embodiment of the present invention.

FIG. 6 represents a front sectional view of a thermal laminate, in accordance with a third embodiment of the present invention.

FIG. 7 represents a front sectional view of a thermal laminate, in accordance with a fourth embodiment of the present invention.

FIG. 8 illustrates a flow diagram depicting a method for assembling a thermal laminate in accordance with an embodiment of the present invention.

FIG. 9 illustrates a flow diagram depicting a method for assembling a thermal laminate in accordance with another embodiment of the present invention.

FIG. 10 illustrates a flow diagram depicting a method for placing a thermal laminate on an assembly to provide heat dissipation in the vicinity of a PCMCIA card, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

The present invention provides a thermal management device for heat dissipation in electronic devices. More particularly, the present invention discloses a thermal laminate for the dissipation of heat generated through a Personal Computer Memory Cards International Association (PCMCIA) card when installed in an electronic device or other related devices. The thermal laminate includes a top film layer, a middle gap filler layer and a bottom layer. The top film layer provides an interface for the thermal laminate. The middle gap filler layer is disposed underneath the top film layer, and provides a thermal pathway in the thermal laminate. The bottom layer is disposed underneath the middle gap filler layer, and provides a grip for the middle gap filler layer and the top film layer to form a structure for the thermal laminate. The bottom layer is selected from either a thermal adhesive layer or an aluminum foil layer. Other embodiments of the thermal laminate are also described for a better understanding of the invention.

The present invention will now be described with reference to the accompanying drawings. The drawings are being used to illustrate the inventive concept, and are not intended to limit the invention to the embodiments illustrated therein.

As used herein, a “mil” is a unit of length equal to one thousandth (10⁻³) of an inch (0.0254 millimeter). A “mil” and can be used, for example, to specify the diameter of wire or the thickness of materials sold in sheets.

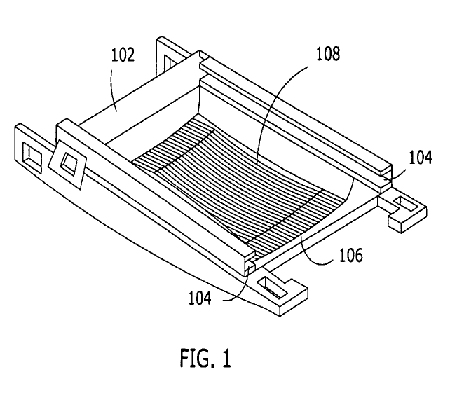

FIG. 1 represents a perspective view of an assembly 102 installed in an electronic device, in accordance with an embodiment of the present invention. The assembly 102 includes a base section 106, a slot pair 104 and a heat sink 108. The slot pair 104 provides movement for a PCMCIA card or some other related device within the assembly 102. The assembly 102 is fixed on a printed circuit board structure inside the electronic device. Examples of the electronic device include, but are not limited to, a laptop, a notebook, a mobile phone, and a sub notebook. The heat sink 108 is placed on the base section 106 of the assembly 102. A heat sink may be a dedicated, thermally-conductive metal plate, or simply the chassis or circuit board for the device. The bottom side portion of the heat sink is defined by an aluminum heat conducting plate or other related materials. The heat transfer efficiency can be improved by using an interface. The interface is a layer of a thermally-conductive, electrically-insulating material, which is interposed between the heat sink and electronic component, such as a PCMCIA card, to fill in any surface irregularities and to eliminate air pockets. Previously, silicone grease or wax filled with thermally-conductive filler, such as aluminum oxides, were used for this purpose. These materials usually are semi-liquid or solid at normal room temperature, but may liquefy or soften at elevated temperatures to flow and better conform to the irregularities of the interfacing surfaces. Various types of heat sink designs are defined in IBM TDB (Technical Disclosure Bulletin) No. NA9001182 “Aluminum Nitride Heat Sink to the Chip”, Jan. 1, 1990 vol. 32 No. 8 Apps. 182-183.

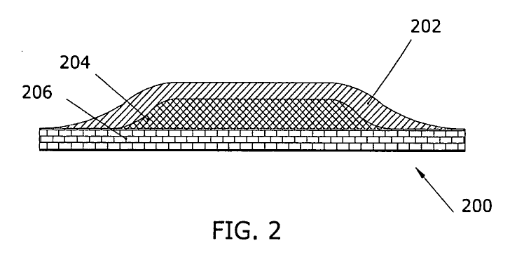

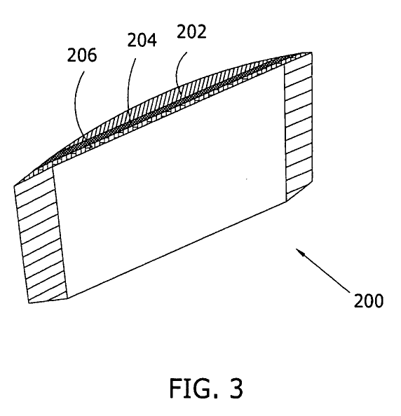

FIG. 2 and FIG. 3 represent a front sectional view of a thermal laminate 200 and a perspective view of the thermal laminate 200, respectively, in accordance with an embodiment of the present invention. The thermal laminate 200 provides for dissipation of heat generated on and around a PCMCIA card during operation, when the PCMCIA card is installed in the electronic device such as a laptop, a notebook, a mobile phone, a sub notebook, etc. The thermal laminate 200 includes a top film layer 202, a middle gap filler layer 204 and a bottom thermal adhesive layer 206. The top film layer 202 provides an interface for the thermal laminate 200. The interface provides various properties for the thermal laminate 200 during operations. Examples of such properties include, but are not limited to, a low friction, high tear resistant, soft conformal surface. These properties provide smooth movement within the assembly, and also close mating contact between interfacing surfaces to provide better heat dissipation.

The top film layer 202 can be a tedlar film having a thickness of 1 mil. However, the thickness of the tedlar film layer can be varied based on specific requirements and usage. The high tensile and tear strength, inertness, thermal stability, and nonstick properties of a tedlar film make it an excellent film for multilayer board production or for other types of laminates. The polyvinyl fluoride binder used in tedlar film is flexible and strong. Therefore, the film contains no plasticizers or reinforcing agents that could leach out during storage or processing, causing brittleness or weakening of the film. Hence, tedlar film products retain their properties throughout processing or for extended storage periods. The tedlar films are available in a thickness, which varies between 0.5 mil to 2.0 mil. The tedlar films are also available as clear or translucent films, and in several surface finishes.

A TMR10SM3 (DuPont) tedlar film has been designed for laminate manufacturing, where operating temperatures range from 188-193° C. (370-380° F.). In addition, a TPC 10SM3 (DuPont) tedlar film provides an excellent cushion, minimizing pitting and denting of the laminate surface from foreign material during processing. A TML 10SM3 (DuPont) tedlar film enhances the performance in multilayer vacuum lamination process due to its unique low volatile formulation. A TTR20SG4 (DuPont) tedlar film is used in the manufacturing of flexible or rigid-flex printed wiring boards due to its conformal properties, toughness, and inertness to bonding adhesives.

The middle gap filler layer 204 is disposed below the top film layer 202. The middle gap filler layer 204 provides a thermal pathway for heat radiation generated through the PCMCIA card. The middle gap filler layer 204 is a thermally conductive gap filler. The thermally conductive gap filler has a carrier, which can be selected from either a fiberglass carrier or an aluminum foil carrier. The G570/580 (Chomerics) material is a fiberglass carrier. The A570/580 (Chomerics) material is an aluminum foil carrier with a pressure sensitive adhesive for easy placement. The middle gap filler layer 204 is made of Chomerics 570 gap filler. However, other materials can also be used based on specific requirements and usage. These gap filler materials consist of an ultra-soft silicone elastomer filled with ceramic particles. THERM-A-GAP (Chomerics) elastomers are used to fill air voids between electronic component boards or high temperature components and heat sinks, metal enclosures, and chassis. The exceptional conformability of these materials enables these materials to blanket highly uneven surfaces, such as mating surfaces, in order to efficiently transfer heat away from individual component or entire boards.

The gap fillers are characterized by various parameters such as thermal conductivity, conformal ability, flammability, physical strength, and surface type. The gap fillers can be varied on the basis of size and shape. The gap fillers may be of any general shape including spherical, flake, platelet, irregular, or fibrous, such as chopped or milled fibers, but preferably will be a powder or other particulate form to assure uniform dispersal and homogeneous mechanical and thermal properties. Gap fillers with a size range of about 0.02-0.10 mils are generally preferred. The gap filler may be an electrically-nonconductive gap filler. Thermally-conductive fillers are also available, which include boron nitride, aluminum oxide, aluminum nitride, titanium diboride, magnesium oxide, zinc oxide, silicon carbide, beryllium oxide, antimony oxide, and mixtures thereof. Such fillers characteristically exhibit a thermal conductivity of about 25-200 W/m° K.

The bottom thermal layer 206 is disposed below the middle gap filler layer 204. The bottom thermal adhesive layer 206 provides a grip to the top film layer 202 and the middle gap filler layer 204 to form a structure for the thermal laminate 200. The bottom layer is a thermal adhesive layer made of a thermally conductive adhesive tape. The adhesive tape can be selected from a THERMATTACH T404 (Chomerics) tape, a THERMATTACH T405 (Chomerics) tape, or a THERMATTACH T412 (Chomerics) tape depending on the requirements and usage. The thermal adhesive layer can be a layer of a pressure sensitive adhesive, which may be acrylic or silicone-based depending upon the package material of the electronic component. THERMATTACH (Chomerics) tapes are a family of acrylic and silicone pressure-sensitive adhesive tapes designed to securely adhere heat sinks. Thermal tapes are used mainly for their mechanical adhesive properties rather than for their thermal properties. The thermal conductivity of these tapes is moderate and their thermal performance depends on the contact area that can be achieved between the bonding surfaces.

The thermal laminate 200 provides sliding contact between a PCMCIA card surface and a heat sink surface inside the assembly 102. The sliding contact provides a close housing for the thermal laminate 200 within the assembly. The sliding contact also provides a close mating contact between the enclosing surfaces to provide better thermal management during operation.

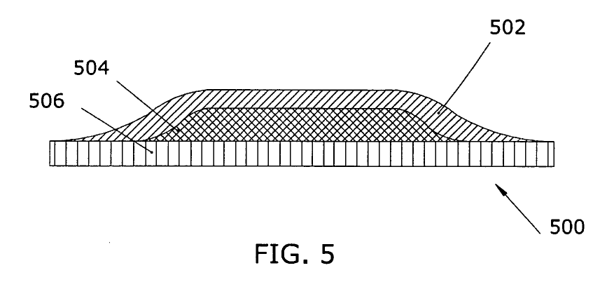

In a second embodiment as depicted in FIG. 5, a thermal laminate 500 includes a top tedlar film layer 502, a middle gap filler layer 504, and a bottom copper foil layer 506. The top film layer 502 provides an interface to the thermal laminate 500. The middle gap filler layer 504 is disposed underneath the top film layer 502. The middle gap filler layer 504 provides a thermal pathway for the heat radiation. The bottom copper foil layer 506 is disposed underneath the middle gap filler layer 504. The bottom copper foil layer 506 provides a grip to the top film layer 502 and a middle gap filler layer 504. The copper foil is ideal for printed wiring board modification and repair. The copper foil is also designed for use as electro-magnetic interference (EMI) and radio-frequency interference (RFI) shielding on the electronic devices or other small electromagnetic components, such as transformer and reactor coils, instruments and control motors. The copper foil has outstanding adhesion provided by an insulating, chemically-pure, non-corrosive solvent, and heat resistant thermosetting acrylic adhesive. The copper foil offers excellent soldering properties. An AD350A (Arlon) copper foil is supplied with 1/2, 1 or 2 ounce electrodeposited copper on both sides. Other types of foils, such as copper weights and rolled copper foil are also available. Aluminum, brass or copper plate can provide an integral heat sink and mechanical support to the substrate. Depending on the requirements and usage, a copper foil can be selected based on various parameters, such as dielectric thickness, cladding, panel size and any other special considerations.

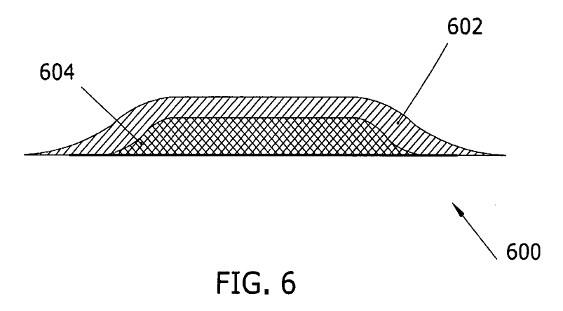

In a third embodiment, a thermal laminate 600 includes a top tedlar film layer 602 and a gap filler layer 604 as shown in FIG. 6. The top film layer 602 provides enveloping edges beyond the gap filler layer 604. The top film layer 602 provides an interface to the thermal laminate 600. The gap filler layer 604 is disposed underneath the top film layer 602. The gap filler layer 604 provides a thermal pathway to heat radiation emitted from the PCMCIA card. The gap filler layer 604 also provides a grip to the top film layer 602.

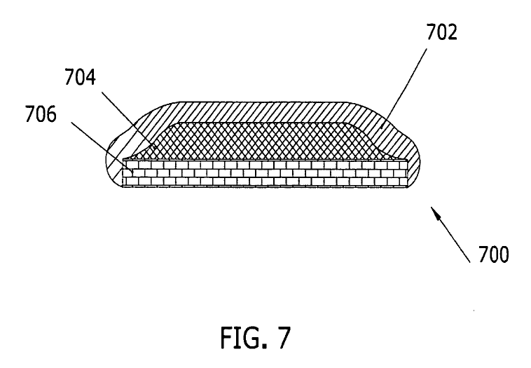

In a fourth embodiment, a thermal laminate 700 includes a top tedlar film layer 702, a middle gap filler layer 704 and a thermal adhesive bottom layer 706. The middle gap filler layer 704 and the thermal adhesive bottom layer 706 can be configured for different sizes as shown in FIG. 7. The top tedlar film layer 702 is wrapped around to provide enveloping edges over middle gap filler layer 704 and the bottom layer 706. The top film layer 702 provides an interface for the thermal laminate 700. The middle gap filler layer 704 is disposed underneath the top film layer 702. The middle gap filler layer 704 provides a thermal pathway for heat radiation. The bottom layer 706 is disposed underneath the middle gap filler layer 704 to provide a grip for the top film layer 702 and a middle gap filler layer 704.

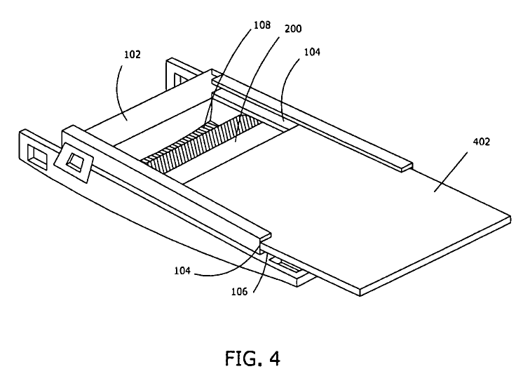

FIG. 4 represents the assembly 102 installed on an electronic device having the present thermal laminate, the heat sink 108 and a PCMCIA card 402 positioned thereon, in accordance with an exemplary embodiment of the present invention. Examples of the electronic device include, but are not limited to, a laptop, a notebook, a mobile phone, and a sub notebook. The heat sink 108 is placed on the base section 106 of the assembly 102. The invented thermal laminate is designed and placed in a manner to provide a close mating between the heat sink 108 and the PCMCIA card 402. The present thermal laminate has sliding contacts for providing movement for a close housing inside the assembly 102.

The generated heat is dissipated from the PCMCIA card 402 through the thermal laminate. The thermal laminate is sandwiched between the heat sink 108 and the PCMCIA card 402 as shown in the FIG. 4. The arrangement is such that the thermal laminate provides a close mating between these surfaces for better thermal management. The heat radiation generated from the PCMCIA card 402 is bypassed to heat sink 108 through the thermal laminate. The thermal laminate provides a soft conformal and a high tear resistive surface for easy and smooth housing within the assembly 102.

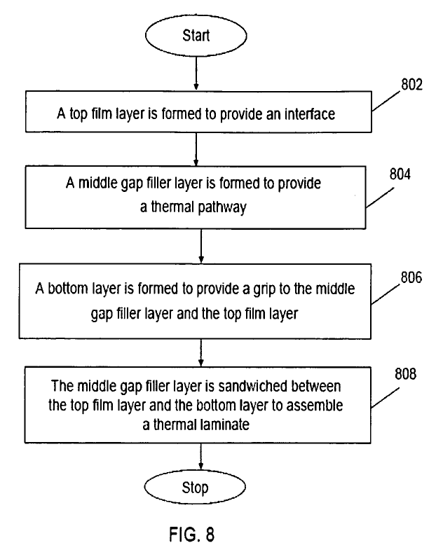

FIG. 8 illustrates a flow diagram depicting a method for assembling a thermal laminate in accordance with an embodiment of the present invention. At step 802, a top film layer is formed. The top film layer provides a resistive surface, a low friction surface and a soft conformal interface for the thermal laminate. At step 804, a middle gap filler layer is formed. The middle gap layer provides a thermal pathway for the heat radiation emitted through the PCMCIA card. At step 806, a bottom layer is formed. At step 808, the middle gap filler layer is sandwiched between the top film layer and the bottom layer to assemble the thermal laminate. The bottom layer provides a grip to the middle gap filler layer and the top film layer. The bottom layer can be made either from a thermal adhesive layer or a copper foil layer.

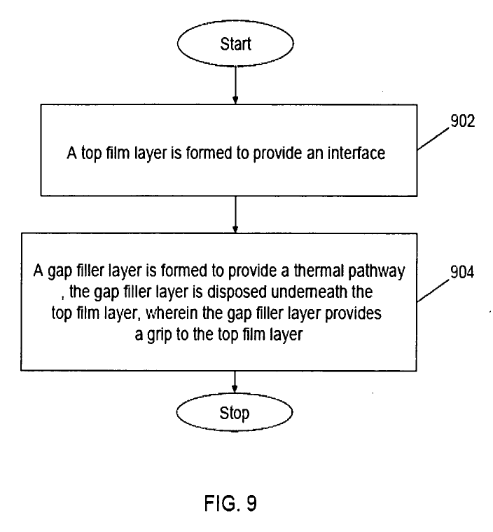

FIG. 9 illustrates a flow diagram depicting a method for assembling a thermal laminate in accordance with another embodiment of the present invention. At step 902, a top film layer is formed. The top film layer provides a resistive surface, a low friction surface and a soft conformal interface for the thermal laminate. At step 904, a gap filler layer is formed. The gap filler layer is disposed underneath the top film layer. The gap filler layer provides a thermal pathway for the heat radiation emitted from the PCMCIA card. The gap filler layer provides a grip to the top film layer. The top film layer provides extended shielding over the gap filler layer.

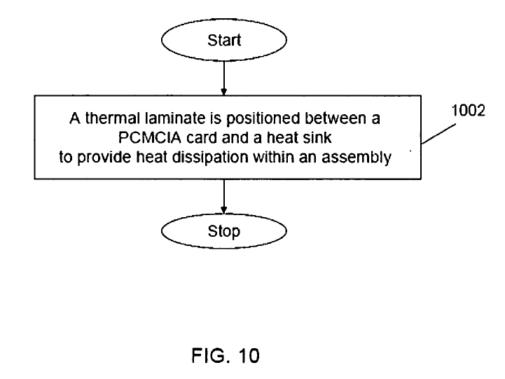

FIG. 10 illustrates a flow diagram depicting a method for placing a thermal laminate on an assembly to provide heat dissipation on a PCMCIA card, in accordance with an embodiment of the present invention. At step 1002, a thermal laminate is positioned between a PCMCIA card and a heat sink to provide heat dissipation within an assembly.

The thermal laminate of the present invention offers many advantages such as sliding contacts for close mating between the enclosing surfaces. Moreover, the thermal laminate design provides thermal pathways to dissipate heat radiation to the ambient environment or heat sink. The heat radiation is emitted from the installed PCMCIA card. The thermal laminate provides a low friction surface with a soft conformal interface to enhance its operability when in use.

Various other embodiments are possible and are within the spirit of the invention. The aforementioned embodiments are meant to be for explanatory purposes only and are not intended to limit the invention in any manner. The thermal laminate may be made from various kinds of materials available in the field and known to a person skilled in the art. The invention intends to cover all the equivalent embodiments and is limited only by the appended claims.

What is claimed is:

1. A thermal laminate providing dissipation of heat generated on a PCMCIA card, said thermal laminate comprising:
a top film layer providing an interface and protective sheath for said thermal laminate;
a middle gap filler layer disposed underneath said top film layer, wherein said middle gap filler layer provides a thermal pathway; and
a bottom layer underneath said middle gap filler layer, said bottom layer provides a grip for one or more of said middle gap filler layer and said top film layer.

2. The thermal laminate as claimed in claim 1, wherein said top film layer provides enveloping edges beyond said middle gap filler layer and said bottom layer.

3. The thermal laminate as claimed in claim 1, wherein said bottom layer is a thermal adhesive layer.

4. The thermal laminate as claimed in claim 3, wherein said thermal adhesive layer is a thermally conductive adhesive tape selected from the group consisting of a Thermattach T404 tape, a Thermattach T405 tape, and a Thermattach T412 tape.

5. The thermal laminate as claimed in claim 1, wherein said bottom layer is an aluminum foil layer.

6. The thermal laminate as claimed in claim 1, wherein said top film layer is a tedlar film.

7. The thermal laminate as claimed in claim 6, wherein said tedlar film has a thickness of about 1 mil.

8. The thermal laminate as claimed in claim 1, wherein said middle gap filler layer is a thermal conductive gap filler.

9. The thermal laminate as claimed in claim 8, wherein said thermal conductive gap filler has a carrier selected from the group consisting of a fiberglass carrier, and an aluminum foil carrier.

10. A thermal laminate providing dissipation of heat generated on a PCMCIA card, said thermal laminate comprising:
a top film layer providing an interface and protective sheath for said thermal laminate; and
a gap filler layer positioning underneath said top film layer,
wherein said gap filler layer provides a thermal pathway, and wherein said top film layer provides enveloping edges beyond said gap filler layer.

11. The thermal laminate as claimed in claim 10, wherein said top film layer is a tedlar film.

12. The thermal laminate as claimed in claim 11, wherein said tedlar film has a thickness of 1 mil.

13. The thermal laminate as claimed in claim 10, wherein said gap filler layer is a thermal conductive gap filler.

14. The thermal laminate as claimed in claim 13, wherein said thermal conductive gap filler has a carrier selected from the group consisting of a fiberglass carrier, and an aluminum foil carrier.

15. A method of assembling a thermal laminate comprising:
forming a top film layer to provide an interface;
forming a middle gap filler layer to provide a thermal pathway;
forming a bottom layer to provide a grip to one or more of said middle gap filler layer and said top film layer; and
sandwiching said middle gap filler layer between said top film layer and said bottom layer to assemble said thermal laminate.

16. The method as claimed in claim 15, wherein said top film layer provides enveloping edges beyond said middle gap filler layer and said bottom layer.

17. The method as claimed in claim 15, wherein said bottom layer is a thermal adhesive layer.

18. The method as claimed in claim 17, wherein said thermal adhesive layer is a thermally conductive adhesive tape selected from the group consisting of a Thermattach T404 tape, a Thermattach T405 tape, and a Thermattach T412 tape.

19. The method as claimed in claim 15, wherein said bottom layer is a copper foil layer.

20. The method as claimed in claim 15, wherein said top film layer is a tedlar film.

21. The method as claimed in claim 20, wherein said tedlar film has a thickness of 1 mil.

22. The method as claimed in claim 15, wherein said middle gap filler layer is a thermal conductive gap filler.

23. The method as claimed in claim 22, wherein said thermal conductive gap filler has a carrier selected from the group consisting of a fiberglass carrier, and an aluminum foil carrier.

24. A method of assembling a thermal laminate comprising:
forming a top film layer to provide an interface; and
forming a gap filler layer to provide a thermal pathway,
wherein said gap filler layer is disposed underneath said top film layer, and wherein said gap filler layer provides a grip to said top film layer.

25. The method as claimed in claim 24, wherein said top film layer provides enveloping edges beyond said gap filler layer.

26. The method as claimed in claim 24, wherein said top film layer is a tedlar film.

27. The method as claimed in claim 26, wherein said tedlar film has a thickness of 1 mil.

28. The method as claimed in claim 24, wherein said middle gap filler layer is a thermal conductive gap filler.

29. The method as claimed in claim 28, wherein said thermal conductive gap filler has a carrier selected from a group comprising a fiberglass carrier, and an aluminum foil carrier.

30. A method of placing a thermal laminate on an assembly to provide dissipation of heat comprising positioning said thermal laminate between a PCMCIA card and a heat sink of said assembly.
